(19) United States
(12) Patent Application Publication
(10) Pub. No.: US 2007/0052257 A1
(43) Pub. Date: Mar. 8, 2007

(54) Pick-up truck cargo bed cover and tailgate ramp device

(76) Inventor: William Brittain Allen, Cataula, GA (US)

Correspondence Address: Biddle & Assocaites, PC, Suite 600-183, 6300 Powers Ferry Road, Atlanta, GA, 30339, US

(21) Appl. No.: 11/222,359

(22) Filed: Sep. 8, 2005

(51) Int. Cl. B60P 7/02

(52) U.S. Cl. 296/100.09

(57) ABSTRACT

A cargo bed cover is provided that includes a first panel and a second panel that are attached to each other via a hinge system. A first support beam is attached the bottom surface of the first panel and a second support beam is attached to the bottom surface of the second panel. A traction surface is provided on the top surface of the first panel and second panel. A support strut is connected to the first panel and is extendable between the first panel and an interior surface of a cargo bed.

### TECHNICAL FIELD

The present invention is generally related to truck cargo cover devices. More particularly, the present invention is related to cover device for the cargo bed of a pick-up truck.

### BACKGROUND OF THE INVENTION

Cover devices for covering the cargo area of, for example, the cargo bed of a pick-up truck are known. Similarly, there are ramp devices known that may be used to load/unload cargo into/out of the cargo bed area. These cover and ramp devices are typically separate and distinct devices, each of which must be separately manufactured, distributed, installed and used in conjunction with a pick-up truck.

Often time's users of pick-up trucks have the need to load cargo which is too large to manually pick up and hand place into the cargo bed. In order to load heavy cargo dollies or hand trucks may be needed to move the load. Certain larger loads may have wheels and be self powered, for example, a motorized multi-wheel all terrain vehicle or motorcycle. These types of cargo loads must either make use of a loading dock facility or acquire a portable ramp system to allow cargo to be loaded via the ramp. Loading dock facilities are very convenient as they allow cargo to be loaded into the pick-up truck bed from a level that is the same/closely the same as the height of the pick-up truck bed and tailgate. Unfortunately, cargo to be loaded into a pick-up truck can not always be first transported to a loading dock facility. Further, to do so requires substantial time and inconvenience. This method does not provide a convenient way of loading cargo while using the pick-up truck out in the field where loading dock facilities are not available.

Some known portable ramp systems require the system to be installed or connected to the pick-up truck in a permanent/semi-permanent fashion that does not allow the ramp to be un-installed or removed easily. These systems are generally substantial in size and weight and detract from the general appearance of the lines of the pick-up truck itself. Other ramp systems are available, however these types of systems typically must be placed into the cargo bed to be transported out into the field for use and take up substantial space within the cargo bed.

Known cargo bed covers are designed to enclose the cargo bed of a pick-up truck to keep environmental elements, as well as thieves, out of the cargo bed. These cargo beds are not designed to provide the additional function of acting as a tail-gate ramp for use in loading/unloading cargo into/out of the cargo bed. Similarly, tailgate ramps are known that provide the ability to load/unload cargo to/from the cargo bed of a pick-up truck. These ramps, however are not designed, nor do they contemplate, the providing a cover for the cargo bed of a pick-up truck.

In order to provide a pick-up truck with both a cargo bed cover and a tailgate ramps system, it is typically necessary for an end user to purchase both a bed cover device, as well as a tailgate ramp system. This is relatively expensive. Further, both known cover devices as well as ramp devices are generally bulky and difficult to maneuver, particularly if it is desired to remove them from attachment to a pick-up truck. Thus, a heretofore unaddressed need exists in the industry to address the aforementioned deficiencies and inadequacies.

### SUMMARY OF THE INVENTION

The present invention provides a truck cargo bed cover device. More particularly, the present invention is related to truck cargo bed cover devices that may be alternately used as a tail-gate ramp device for accessing and loading/unloading a cargo bed. In one embodiment, the device includes a first panel and a second panel that are joined to each other via a hinge. Each of the first panel and the second panel are connected to a support structure that is attached to the under side of each of the panels.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a diagram showing a typical pick-up truck 25 having a cargo bed 30 that includes side walls 160 and a tail gate 35;

FIG. 2 is a diagram depicting an embodiment of the invention 100 mounted on a pick-up truck so as to cover the cargo bed of the pick-up truck;

FIG. 3 is a diagram further depicting details of the invention 100;

FIG. 4A is a diagram depicting an embodiment of the invention attached to the tail gate of a pick-up truck so as to provide a ramp for accessing the cargo bed of the pick-up truck;

FIG. 4B is a diagram depicting an embodiment of the invention secured via travel bracket 75 in manner that allows for the cargo bed 35 to accommodate cargo that extends above the cargo bed 35;

FIG. 4C is a diagram further showing travel bracket 75 mounted inside cargo bed 30;

FIG. 4D is a diagram further showing cover ramp 100 stowed away inside the cargo bed 30 and secured via travel bracket 75;

FIG. 4E-FIG. 4G are diagrams depicting various embodiments of a travel bracket 75;

FIG. 5 is a top view of the invention showing an embodiment of the invention wherein a traction enhancing texture 300 is formed on the top surfaces of the panels 102 and 104;

FIG. 6 is a top view of the invention showing an embodiment of the invention wherein a traction enhancing layer 325 is applied to the top surfaces of the panels 102 and 104;

FIG. 7A is a bottom view showing details of one embodiment of the panels 102 and 104;

FIGS. 7B, 7C and 7D are diagrams depicting various embodiments of support bean 110;

FIG. 7E is a diagram depicting further details of support arm 108;

FIG. 8A and FIG. 8B are diagrams depicting an embodiment of a latching mechanism 800 for securing the cargo bed cover 100 to the cargo bed of pick-up truck 25;

FIG. 9 is a diagram depicting a further embodiment of a latching mechanism 800 for securing the bed cover 100 to the cargo bed of pick-up truck 25;

FIG. 10A-FIG. 10C are diagrams depicting a further embodiment of a latching mechanism 800 for securing the cargo bed cover 100 to the cargo bed of pick-up truck 25;

FIG. 11 is a diagram depicting a further embodiment of a latching mechanism 800 for securing the cargo bed cover 100 to the cargo bed of pick-up truck 25;

FIG. 12A and FIG. 12B are diagrams depicting embodiments of support struts 110;

FIG. 14A-FIG. 14B are diagrams depicting an embodiment of ramp cover 100 in which a weather seal 1400 is provided to keep environmental elements from passing into the cargo bed 30;

FIGS. 15A and 15B are diagrams illustrating an embodiment of the invention which a panel lift assist mechanism 1500 is provided to aid a user in lifting a cover panel;

FIG. 16A-FIG. 16D are diagrams depicting an embodiment of the invention in which the ramp cover 100 is configured to provide latch openings 500 in an alignment with a stake box tie down mechanism;

FIG. 17B is a diagram depicting details of the clamp 1750;

FIG. 17C is a diagram depicting details an embodiment of the invention in which an alignment tab 1775 is provided;

FIG. 17D is a diagram depicting a tie down mechanism 1600 in relation to the side wall 160 and the cargo bed cover 100;

FIG. 17E-FIG. 17H are diagrams depicting further embodiments of the clamp 1750; and

FIG. 18 is a diagram depicting

### DETAILED DESCRIPTION OF THE INVENTION

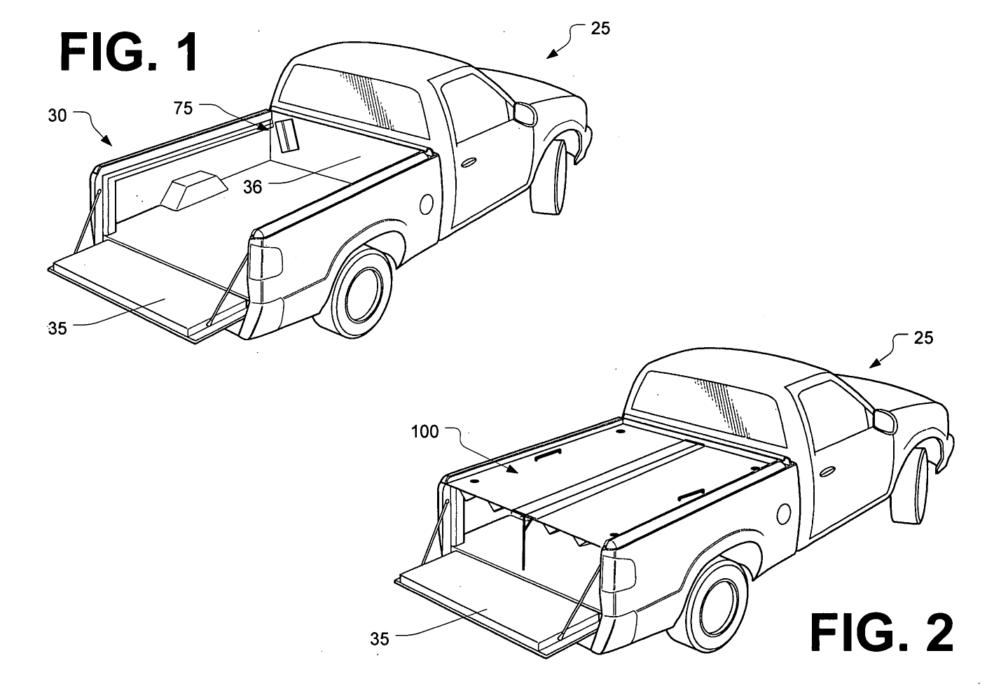

FIG. 1 shows a typical pick-up truck 25 that includes a cargo bed 30, tail gate 35, side walls 160 and forward wall 36. The cargo bed has an interior length “L” and width “W”. The typical pick-up truck cargo bed 30 will include stake pockets (not shown) along the top of the side walls 160. The typical pick-up truck will be provided with a cargo bed 30 that includes two or four stake pockets located at or near the ends of the side walls 160.

The invention is designed to be adapted for use on the typical pick-up truck 25. FIG. 2 shows an example of a cargo bed cover 100 mounted to a pick-up truck 25 so as to cover the cargo bed 30. In this example, the cargo bed cover 100 extends across the cargo bed 30, with the outer edges of the cargo bed cover 100 resting in part on a respective side wall 160.

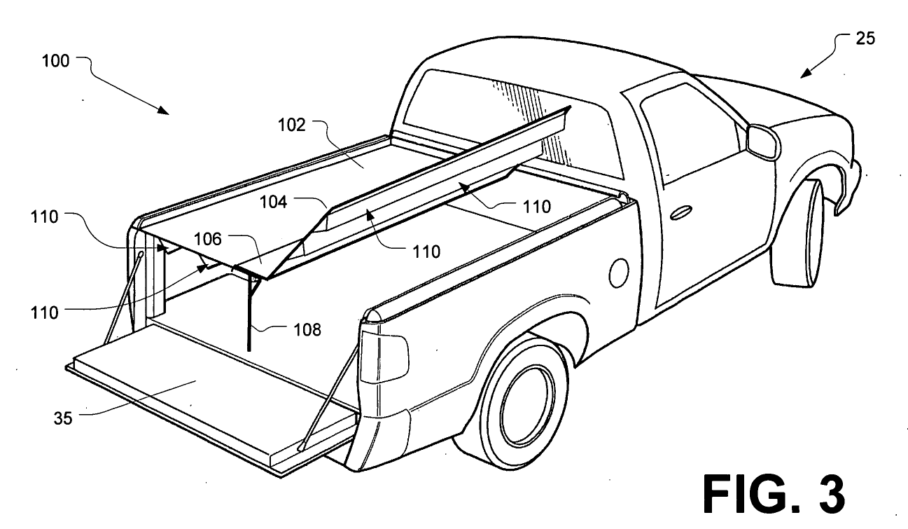

With reference to FIG. 3, cargo bed cover 100 may be configured to include a first panel 102 and a second panel 104. Panel 102 is connected to panel 104 via a hinge system 106. Both panel 102 and 104 are configured to include one or more support beams 110. Each of the support beams 110 are attached to the underside of each of the panels 102 and 104. A support strut 108 is provided. In this embodiment, the support strut 108 is attached to the cargo bed cover toward the rear of the cargo bed cover and near the joint between the panel 102 and the panel 104. The support strut 108 acts to support the center portion of the cargo bed cover when the tailgate 35 is in the “lowered” (or open) position as shown in FIG. 3. It should be noted that the cargo bed cover 100 may be configured so that the panels 102 and 104 are directly supported by the tailgate 35 when the tailgate 35 is in an “up” or closed position. However, the cargo bed cover 100 may also be configured so that the panels 102 and 104 are always supported by the support strut 108 whether or not the tailgate 35 is opened or closed.

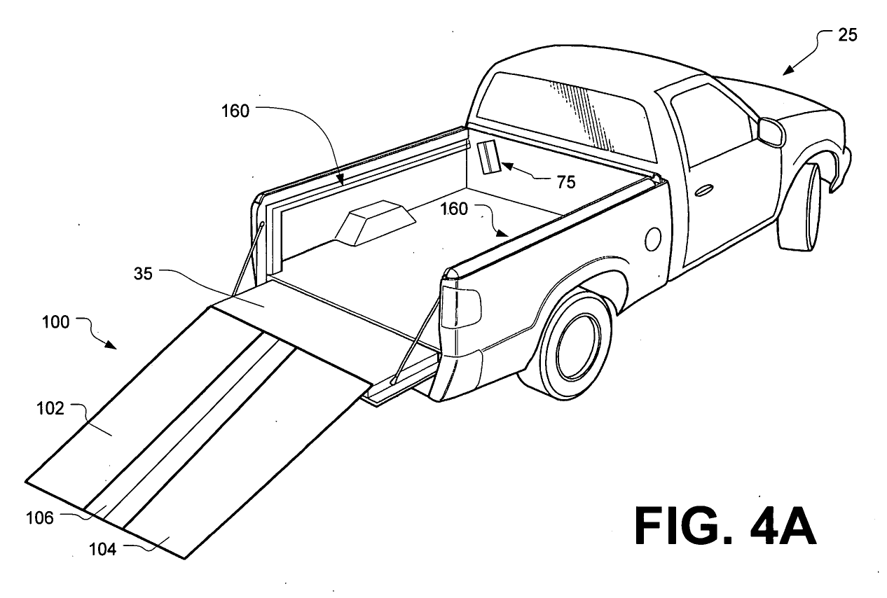

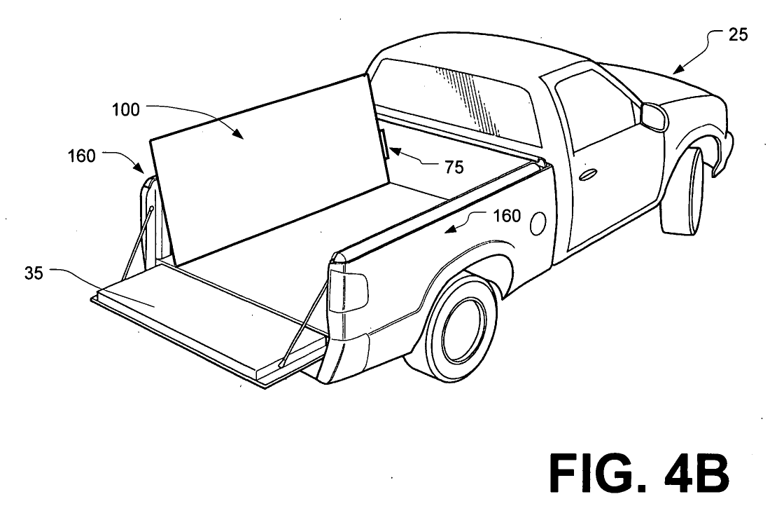

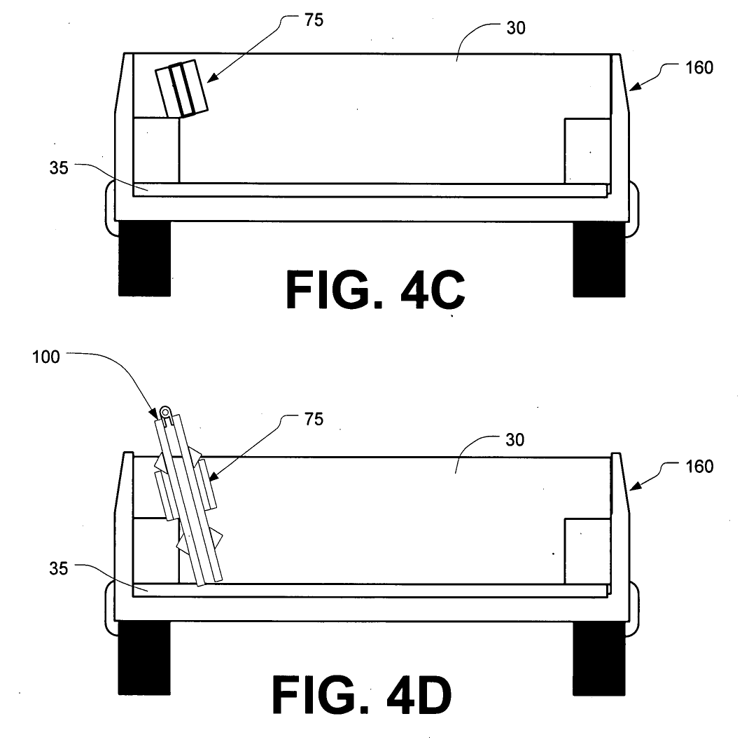

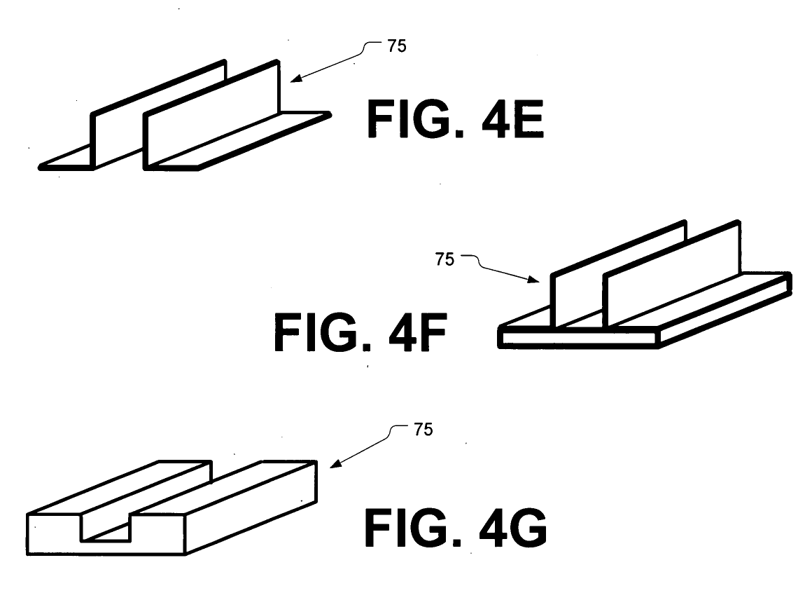

FIG. 4A is a diagram depicting an example of the cargo bed cover 100 in use as a tailgate ramp. One end of the cargo bed cover 100 is placed in contact with the tailgate 35, while the other end is placed on the ground surface 60. In this position, the cargo bed cover 100 is capable of use as a ramp which may be used to load/unload cargo to/from the interior of the cargo bed 30.

After a load has been placed in the cargo bed, it may extend upward above the top of the side walls 160, in which case placement of the cargo bed cover on the pick-up truck 25 to cover the cargo bed 30 is not possible. In order to allow the cargo bed cover 100 to be transported in the pick-up truck along with the cargo load, a travel bracket 75 may be provided. The travel bracket 75 is mounted to the forward wall 36 of the cargo bed 30 and is configured to secure a cargo bed cover 100 (see FIG. 4B) when it is not being used to cover the cargo bed 30. It is preferred that the travel bracket 75 be positioned on the forward wall 36 so that the cargo bed cover 100 can be secured in the cargo bed 30 in a position that will still allow the majority of the area within the cargo bed 30 to be unimpeded by the presence of the cargo bed cover 100. In this way, it is possible for the cargo bed cover 100 to be stowed away in the cargo bed 30 while cargo, such as, for example, an all terrain vehicle or motorcycle, are concurrently accommodated in the cargo bed 30.

FIG. 4B shows the cargo bed cover 100 stowed away, and supported in a generally upright orientation inside the cargo bed 30, via travel bracket 75. In this position, it is possible to transport the cargo bed cover 100 along with any cargo loaded inside the cargo bed 30. This configuration allows cargo that may extend beyond the top of the cargo bed 30 to be easily transported without having to leave the cargo bed cover 100 behind while cargo is being transported to a destination point.

FIG. 4C is a diagram further illustrating travel bracket 75 mounted in the cargo bed 30 of pickup truck 25. FIG. 4D illustrates the cargo bed cover 100 stowed away and secured by travel bracket 75 in a travel position in the cargo bed 30. The travel bracket 75 may be configured in various forms including, but not limited to those illustrated in FIG. 4E-4G.

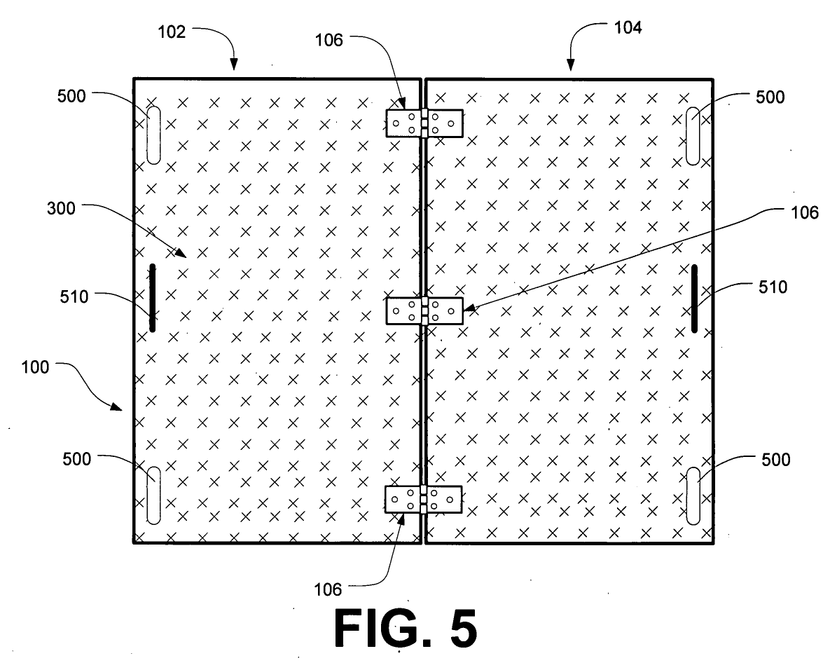

FIG. 5 is a diagram illustrating a top view of one embodiment of the cargo bed cover 100. In this embodiment, the cargo bed cover 100 is configured so that each of the panels 102 and 104 are connected to a handle 510. Each handle 510 is for use in lifting the respective panel 102 or 104 when the cargo bed cover is mounted to the cargo bed 30, so that the contents of the cargo bed 30 may be accessed. Each of the panels 102 and 104 are configured so that the top surface of the panels includes a traction surface 300. The traction surface 300 may be, for example, a raised texture or pattern formed in the panel 102/104. An example of a suitable traction pattern would include what is typically known as “diamond plate” sheet metal. Such metal may be made of aluminum, steel, plastic, fiberglass, or other material. In a preferred embodiment, the panels 102 and 104 are fabricated using, for example, 0.100-0.125 gauge aluminum diamond plate sheet metal.

The hinge system 106 is configured as multiple separate hinges 106, each placed along the common edge between the panels 102 and 104. It will be recognized that, if desired, the hinge system 106 may be configured as a unitary hinge that extends along a majority of the common edge between the panel 102 and 104. Latch openings 500 are provided near each of the four corners of the cargo bed cover 100. In this embodiment the latch openings 500 are generally slotted in shape so that they can accommodate the passing of, for example, a thumb-screw head thru the latch opening 500. It will, however, be recognized that the latch openings 500 may be shaped in various forms, including circular shaped.

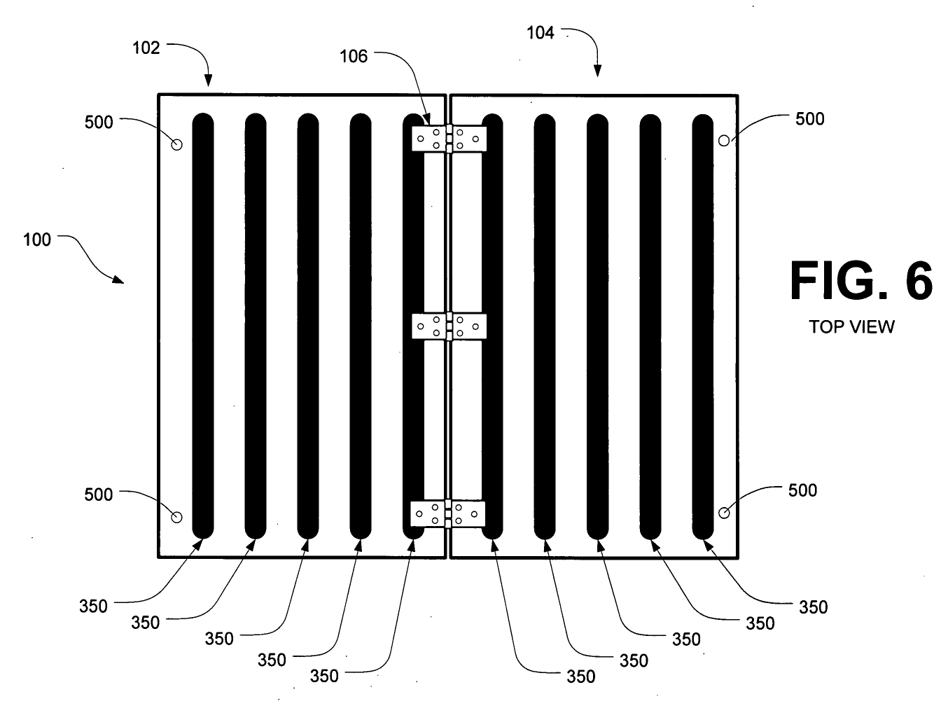

FIG. 6 is a diagram illustrating a top view of another embodiment of the cargo bed cover 100. In this embodiment, the cargo bed cover 100 is configured so that each of the panels 102 and 104 include a traction layer 350 that is attached to the top surface of the panels 102 and 104. The traction layer 350 may be adhered to the panels 102 and 104 via, for example, an adhesive and/or mechanical connector. The traction layer may be made of, for example, rubber, plastic, or other material that provides the cargo bed cover 100 a suitable level of traction. The traction layer 350 may also be fabricated by adhering, for example, sand or other irregular shaped particles onto the top surface of the panels 102 and 104 via an adhesive or coating. In these examples, it can be seen that the latch openings 500 may be made to be circular in shape, if so desired and appropriate.

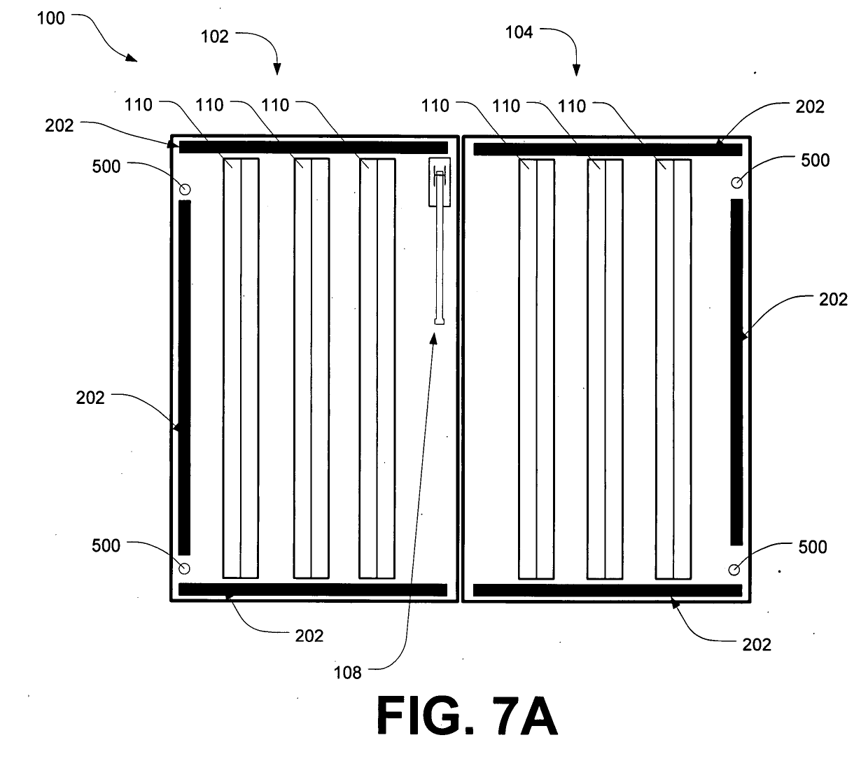

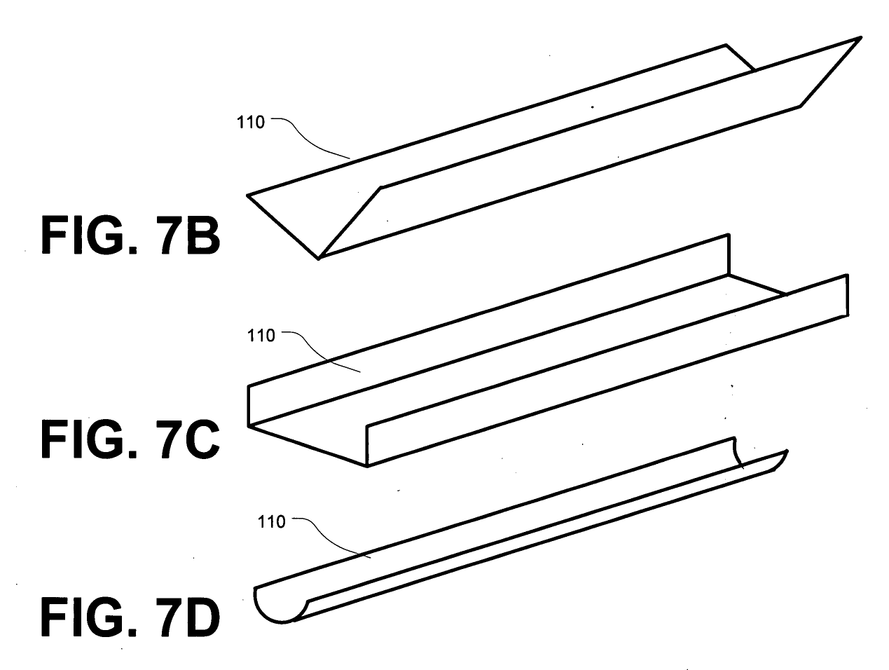

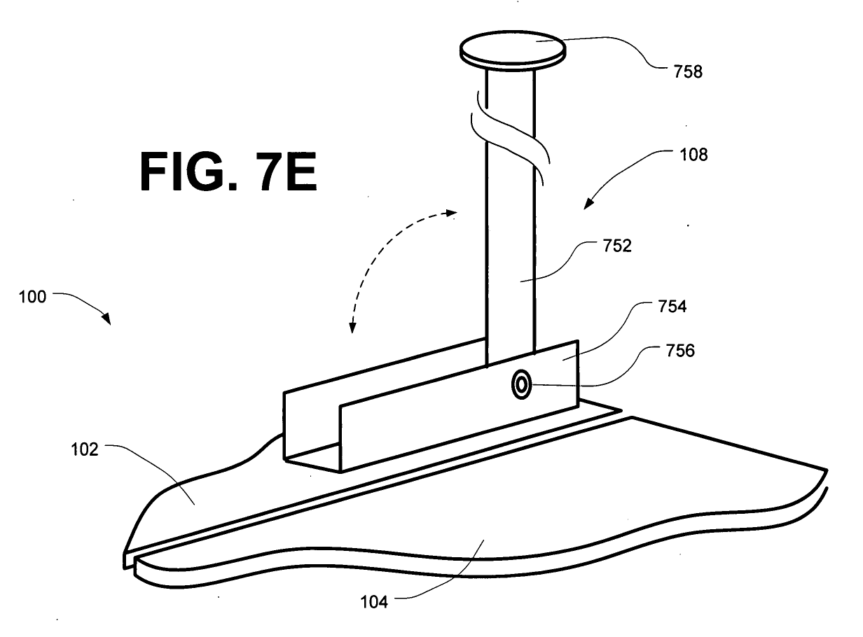

FIG. 7A is a diagram illustrating a bottom view of an embodiment of the cargo bed cover 100. The cargo bed cover 100 includes a series of support beams 110 that are attached to the panels 102 and 104. The support beams 110 may be attached to the panels 102 and 104 via, for example, mechanical connectors, adhesive, wielding or other means that will hold the support beam 110 in close connection with the panel 102 or 104. These support beams extend lengthwise along the panels 102 and 104 and are substantially parallel to each other. While FIG. 7A shows that each panel 102 and 104 is configured to include three support beams 110, it is contemplated that either more or fewer support beams 110 may be provided, as may be desired.

A series of weather seals 202 are provided along the outer edges of each of the panels 102 and 104. When the cargo bed cover 100 is mounted to so as to cover the cargo bed 30 of a pickup truck 25, the weather seals 202 will act to keep moisture and other environmental elements from entering the enclosed cargo bed 30. These weather seals 202 will also act to dampen vibration and associated noise caused by the vibration of the cargo bed cover 100 against the top of the side walls 160 of the cargo bed 30. The weather seals 202 may be made of rubber, cellular foam, plastic or other materials that will provide the desired weather seal or noise damping.

The panels 102 and 104 are configured to include support structures 110 for purposes of enhancing the ability of panels 102 and 104 to sustain a load when the cargo bed cover 100 is used in its capacity as a tailgate ramp. FIG. 7B-FIG. 7D are diagrams illustrating some examples of embodiments of support beams 110. FIG. 7B shows a support beam 110 that is generally “V”-shaped. One implementation of the support beam 110 uses typical angle iron/steel to form the support beam 110. The angle iron is preferably welded to the panels 102/104 along the edges of the angle iron so that a triangular interior space is created between the angle iron and the panel 102/104.

FIG. 7C shows an example of one embodiment of support beam 110 that is “semi-boxed” or “U” shaped. FIG. 7D shows an example of one embodiment of a support beam 110 that is generally arc or semi-circular shaped. It will be recognized that the support beam 110 may also be implemented in other forms, including tubular shape or completely enclosed box shape.

FIG. 7E is a diagram depicting details of one embodiment of the support strut 108. The support strut 108 includes a post 752 that is connected to a mounting bracket 756, via a bolt 754. A foot 756 is attached to an end of the post 752 opposite the mounting bracket 754. The mounting bracket 756 is attached to one of the panels 102 or 104 near the common edge. The post 752 may be rotated about the bolt 756 along a path generally illustrated by the dotted arc shown in FIG. 7E. When the cargo bed cover 100 is mounted to cover the cargo bed 30, the post 756 extends downward, at an angle generally perpendicular to the plane in which panel 102 or 104 lie, so that the foot 758 rests upon the floor of the cargo bed 30, thereby providing support to the cargo bed cover above the cargo bed 30.

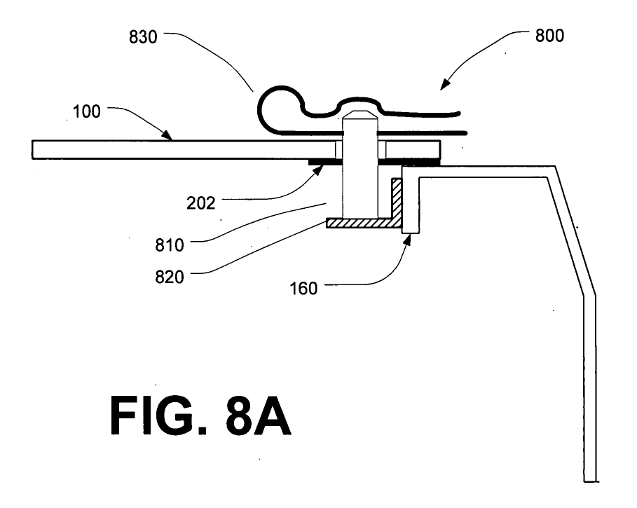

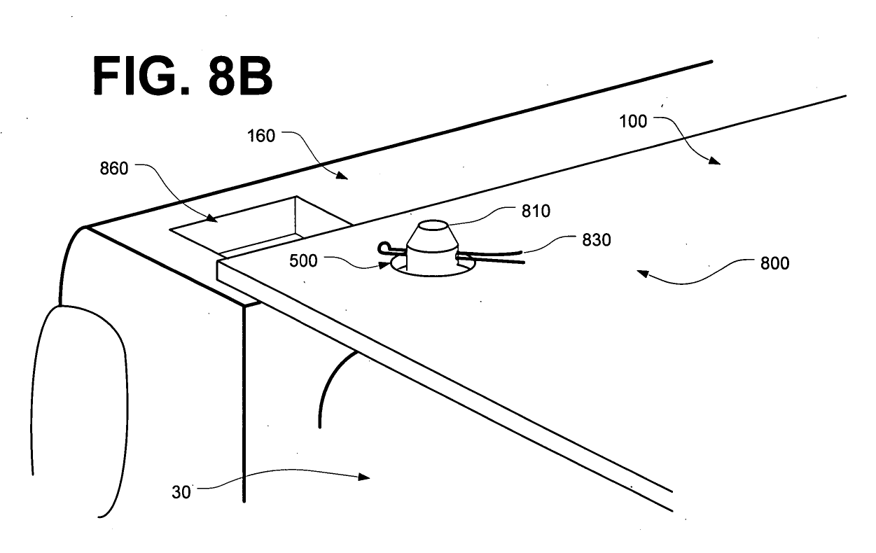

FIG. 8A is a diagram depicting a latch mechanism 800 for securing the cargo bed cover 100 in place over the cargo bed 30. The latch mechanism 800 includes a mounting base 820 that attaches to the interior of a side 160 of the cargo bed 30. The mounting base 800 is connected to a vertical post 810 that extends above the top of the cargo bed 30. When the cargo bed cover 100 is mounted on top of the cargo bed 30, the vertical post 810 will pass thru a respective latch opening 500. A retaining pin 830 may then be attached to the portion of the vertical post 810 that extends thru the latch opening 500 and above the cargo bed cover 100. FIG. 8B depicts a perspective view showing s selected portion of the cover 100 mounted to the cargo bed 30 via latch mechanism 800.

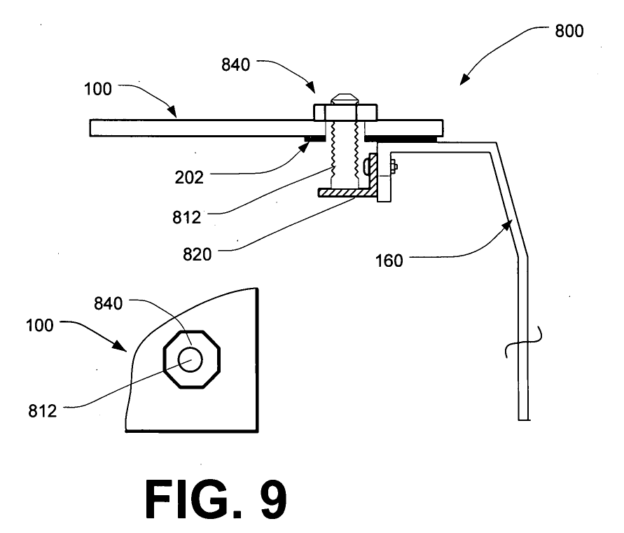

FIG. 9 is a diagram depicting a further embodiment of a latch mechanism 800 for securing the cargo bed cover 100 in place over the cargo bed 30. The latch mechanism 800 includes a mounting base 820 that attaches to the interior of a side 160 of the cargo bed 30. The mounting base 800 is connected to a threaded post 812 that extends above the top of the cargo bed 30. When the cargo bed cover 100 is mounted on top of the cargo bed 30, the vertical post 810 will pass thru a respective latch opening 500. A threaded nut 840 may then be threaded onto the threaded post 812 to secure the cargo bed cover 100 in position against the top of the side 160 of the cargo bed 30.

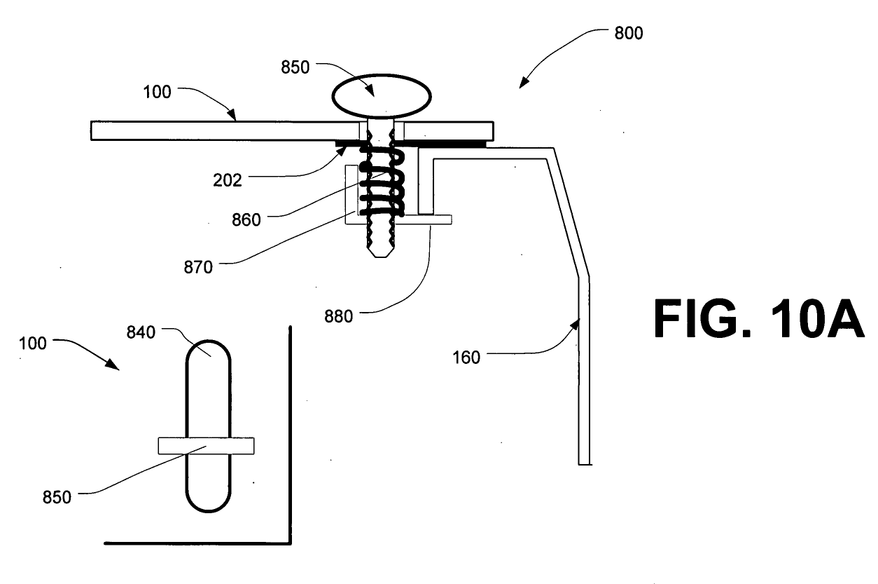

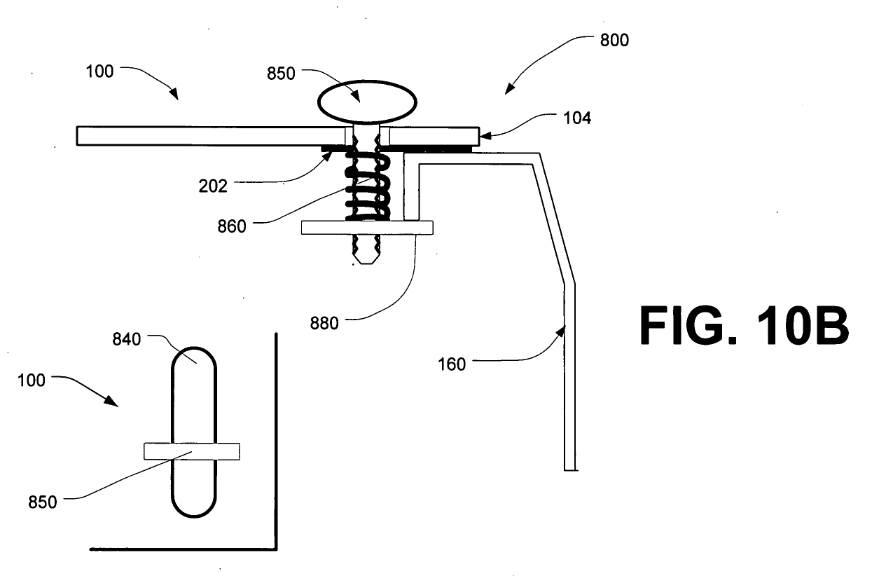

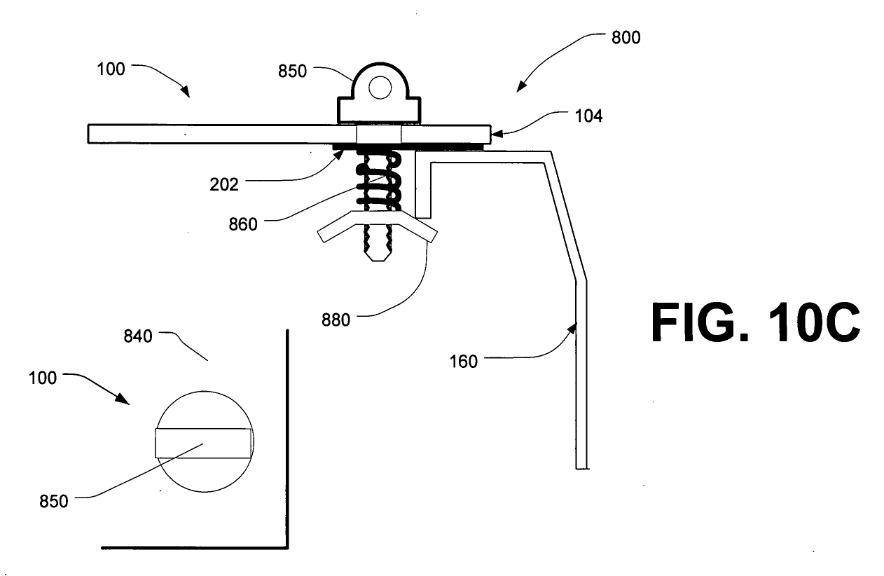

FIG. 10A is a diagram depicting a further embodiment of a latch mechanism 800 for securing the cargo bed cover 100 in place over the cargo bed 30. The latch mechanism 800 includes a side lip 880 that contacts the underside of the interior of side 160. Here the side lip 880 is generally “L”-shaped. The side lip includes a threaded hole thru which a thumb screw 850 is threaded. The threaded portion of the thumb screw 850 extends thru the latch opening 500 and then thru the interior of a coil spring 860 before threading into the side lip 880. By pulling up on the thumb screw 850 and rotating the side lip 880 can be rotated away from the underside of the side wall 160, providing enough clearance of the side lip to pass by the side wall 160 when the respective panel (102 or 104—not shown) of the cargo bed 100 is lifted upward to access the cargo bed 30.

FIG. 10B illustrates an embodiment of the side lip 880 which is generally flat in shape. FIG. 10C illustrates an embodiment in which the latch mechanism includes a side lip 880 that contacts the underside of the interior of side 160. Here the side lip 880 is generally “L”-shaped. The side lip includes a threaded hole thru which a threaded eye bolt 890 is threaded. The threaded portion of the eye bolt 890 extends thru the latch opening 500 and then thru the interior of a coil spring 860 before threading into the side lip 880. By pulling up on the thumb screw 850 and rotating the side lip 880 can be rotated away from the underside of the side wall 160, providing enough clearance of the side lip to pass by the side wall 160 when the respective panel (102 or 104—not shown) of the cargo bed 100 is lifted upward to access the cargo bed 30. In this embodiment the side lip 880 is angled downward relative to the eye bolt 890.

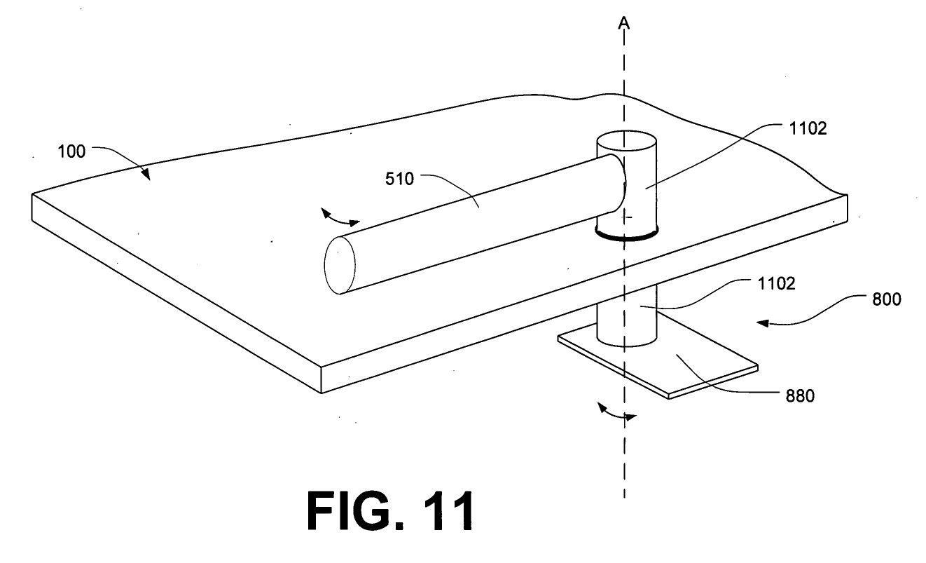

FIG. 11 is a diagram depicting a further embodiment of a latch mechanism 800 for securing the cargo bed cover 100 in place over the cargo bed 30. The latch mechanism 800 is configured as an integral part of a handle 510. In this embodiment, the handle 510 is attached to a vertical post 1102. Vertical post 1102 extends thru an opening in the cargo bed cover 100 and connects to a side lip 880. The handle 510 is generally perpendicular to the vertical post 110 and acts to rotate the vertical post 1102 when moved in a direction generally parallel to the top surface of cargo bed cover 100. By moving the handle 510, the vertical post 1102 is rotated thereby moving the side lip 880 about the axis A. Thru this rotation, the side lip 880 may be moved into and out of contact with the interior under side of the side wall 160 (not shown).

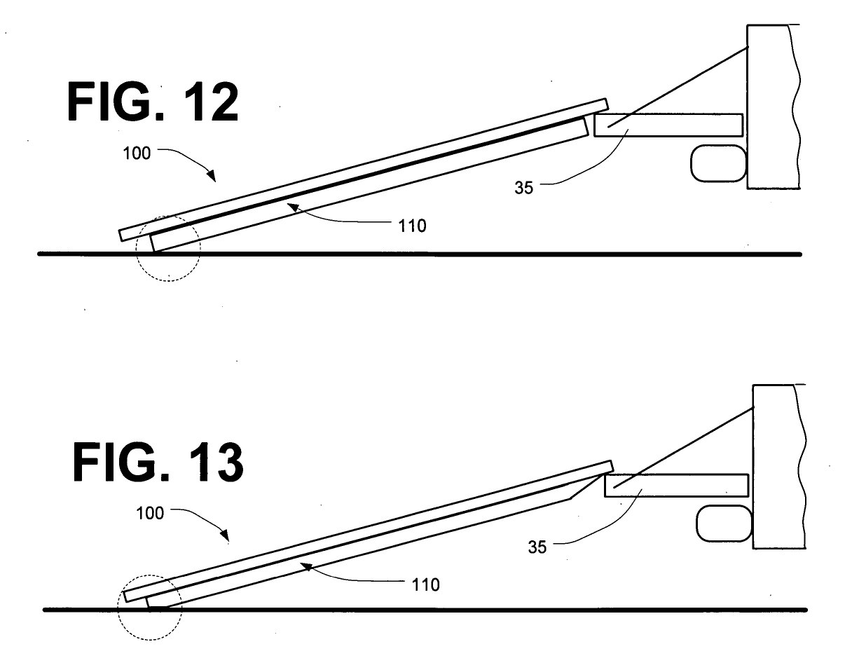

The support beams 110 are preferably aligned along the length of the panels 102 and 104 so that when the cover ramp 100 is in place against the tailgate 35 and the ground 80, the weight of the cover ramp 100, as well as any cargo or vehicle being loaded/unloaded via the cover ramp 100 will be carried and transmitted by one end of the support beam 110 to the ground 80. FIG. 12 and FIG. 13 are diagrams depicting possible implementations of support beams 110. FIG. 12 shows the support beam 110 where the end of the support beam 110 concludes in a 90° corner. The support beam 110 does not extend all the way to the end of the panel nearest the ground 80, but instead it ends back away from the end edge of the panel 102/104. This allows the support beam to carry the weight of the cover ramp and cargo and not the edge of the panel 102/104. In this way the edges of the panels 102 and 104 can be protected from deformation due to directed or forceful contact with the ground or other surfaces. The ground contact point of the support beam 110 will place a high amount of force on the ground surface 80 and may damage certain ground surfaces/covering. In order to reduce this risk the end of the support beam 110 may be mitered to a predetermined angle to allow a greater portion of the support beam 110 to actually come in direct contact with the ground surface 80. FIG. 13 shows the support beam 110 where the end of the support beam is mitered to a predetermined angle relative to the panel 102/104 so that a greater portion of the end of the support beam 110 comes in direct contact with the ground surface 80. In a further embodiment not shown, the support beams 110 may be configured to include contact feet/pads which make contact with the ground surface 80. These pads are preferably sized so that any load applied to the cargo bed cover 100 is evenly distributed to the ground surface without damaging the ground surface or imbedding the support beams 110 into the ground surface 80. The pads may be implemented as a unitary pad which is connected to one or more of the support beams 110 on a given panel 102 or 104.

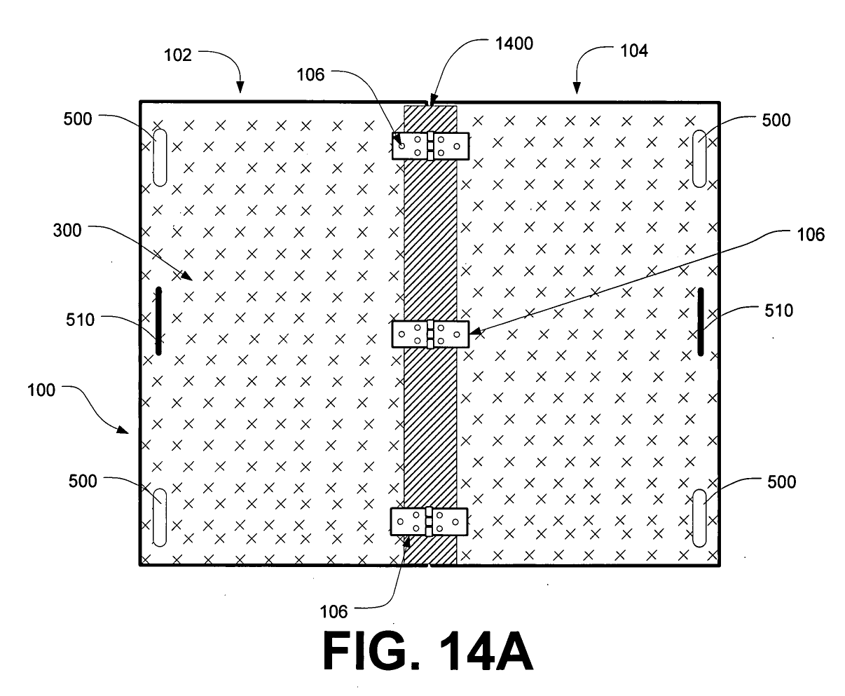

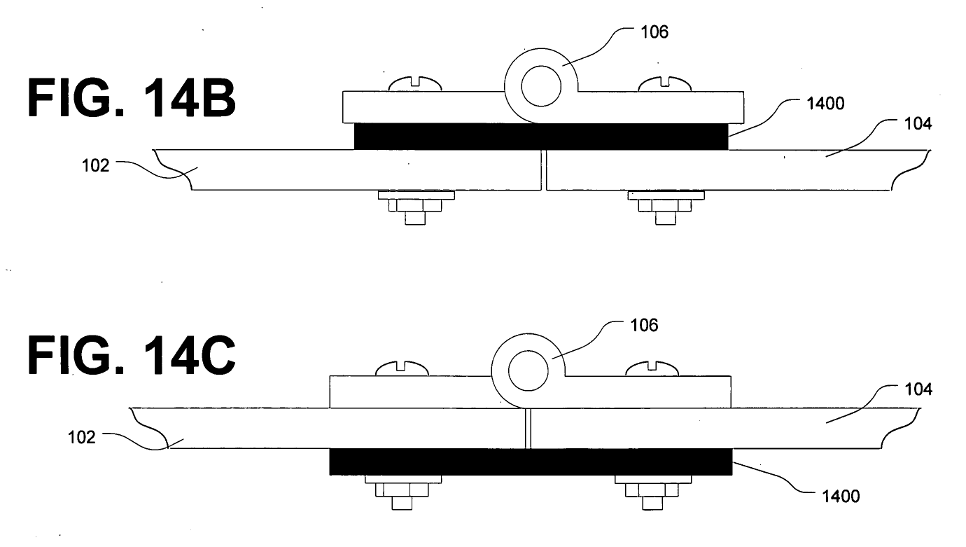

The abutting edges of panels 102 and 104 form a seam there between via which debris and environmental elements, such as rain, can pass into the cargo bed 30. In order to avoid this, a weather seal 1400 is preferably provided along the entire length of the seam as shown in FIG. 14A. The weather seal 1400 may be disposed on the top surfaces of the panels 102 and 104 as shown in FIG. 14B. Alternatively the weather seal 1400 may be disposed on the bottom surfaces of the panels 102 and 104 as shown in FIG. 14B.

The weather seal 1400 may be made of any one of available materials capable of acting as a sealant against environmental elements. Some examples include rubber or plastic layers or strips. These layers or strips may include an adhesive to adhere the surface of each strip in direct contact with the surface of a panel 102/104.

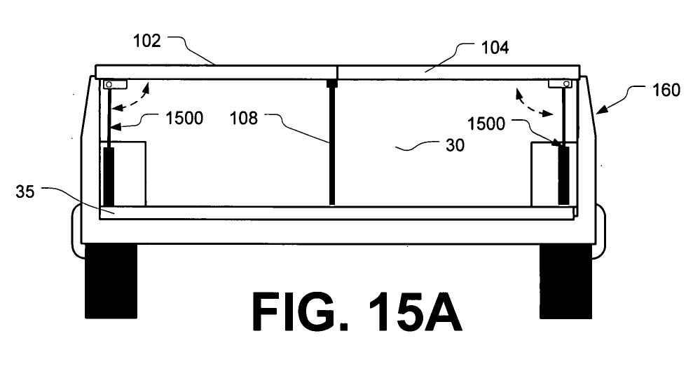

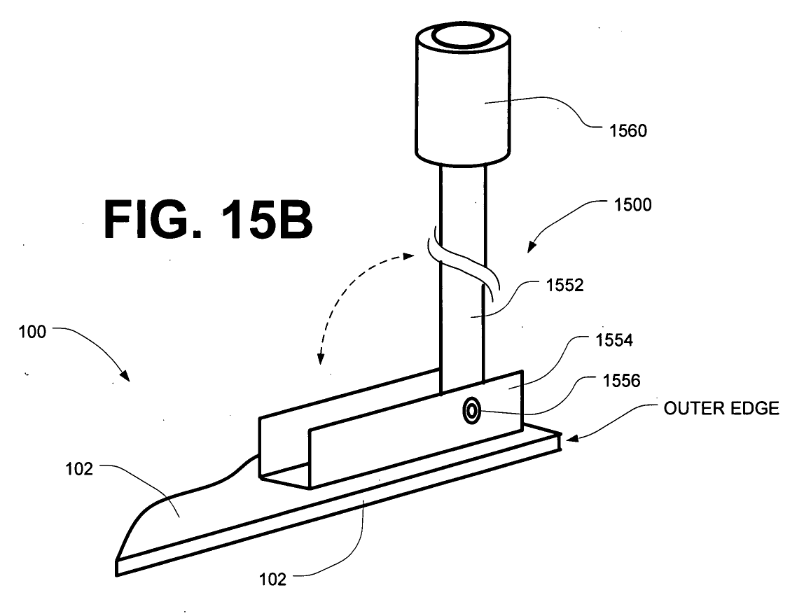

FIG. 15A and FIG. 15B illustrate an embodiment of the invention in which a lift assist mechanism 1500 is provided on the outer edge of each of the panels 102 and 104. A hydraulic extension cylinder 1560 is attached to an end of the post 1552 opposite the mounting bracket 1554. The mounting bracket 1556 is attached to the panel 102 near the outer edge. The post 1552 may be rotated about the bolt 1556 along a path generally illustrated by the dotted arc shown in FIG. 15A. When the cargo bed cover 100 is mounted to cover the cargo bed 30, the post 1556 extends downward, at an angle generally perpendicular to the plane in which panel 102 lie, so that the foot 1558 rests upon the floor of the cargo bed 30. The compression cylinder is biased to push outward (upward) to counter the weight of the panel 102/104, thereby assisting a user in lifting the panel 102.

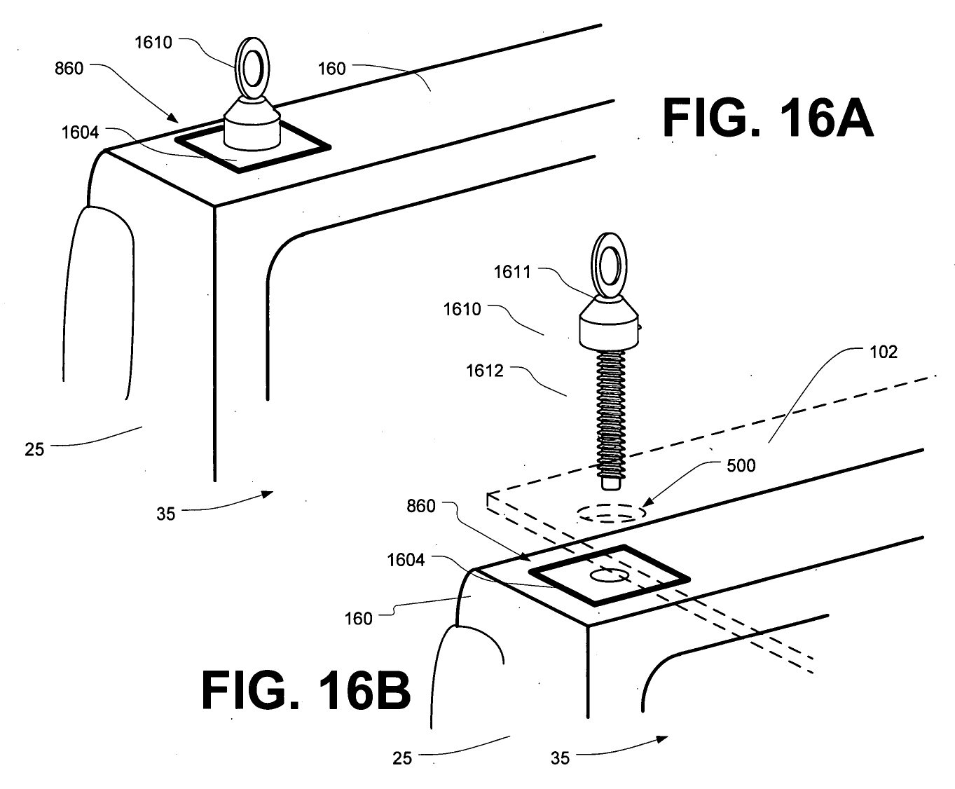

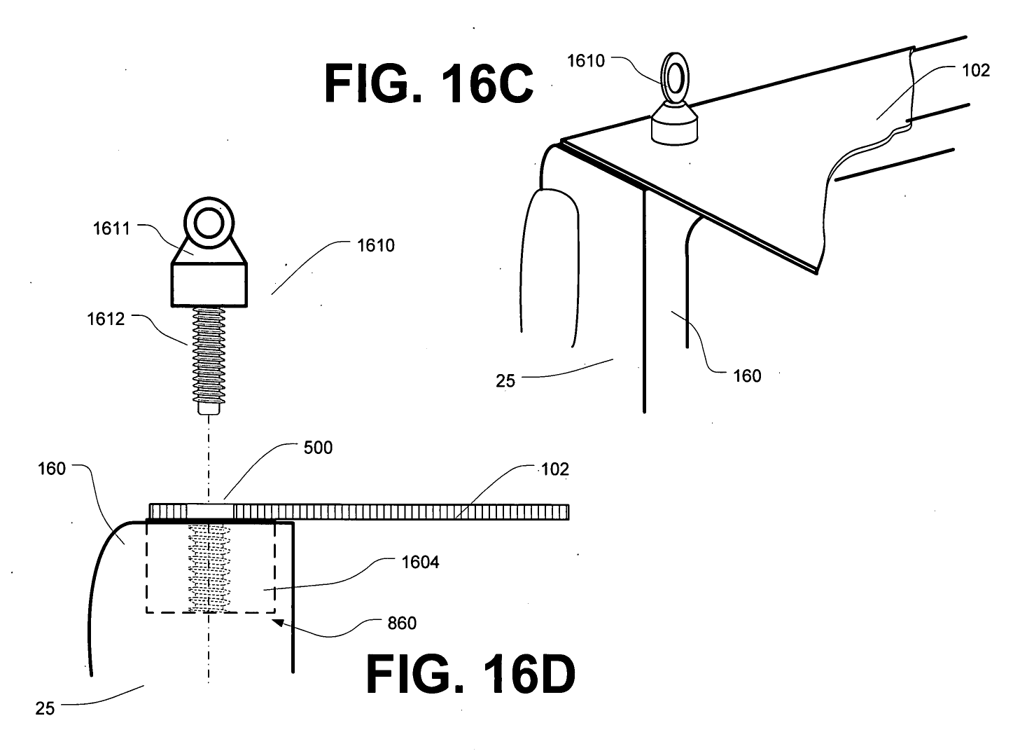

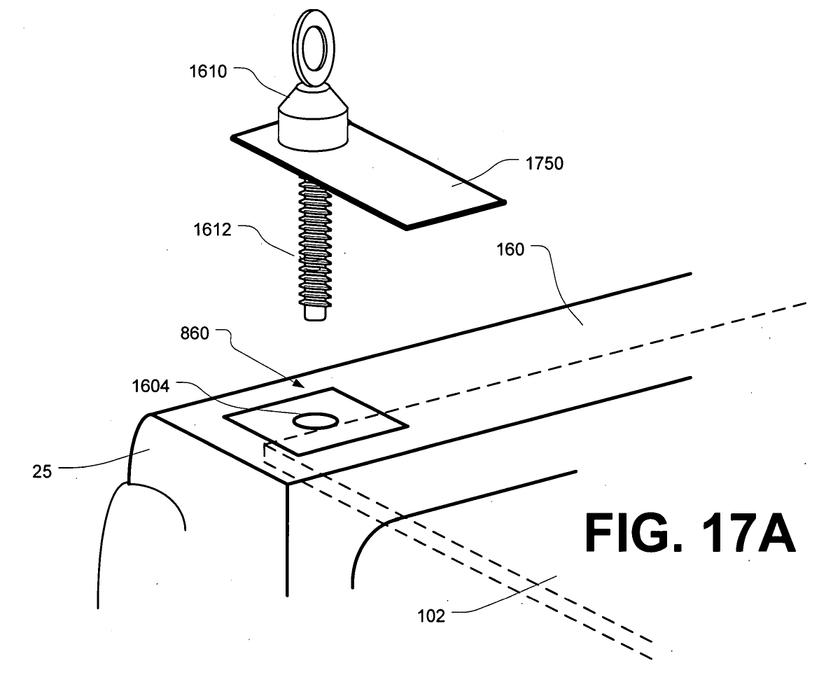

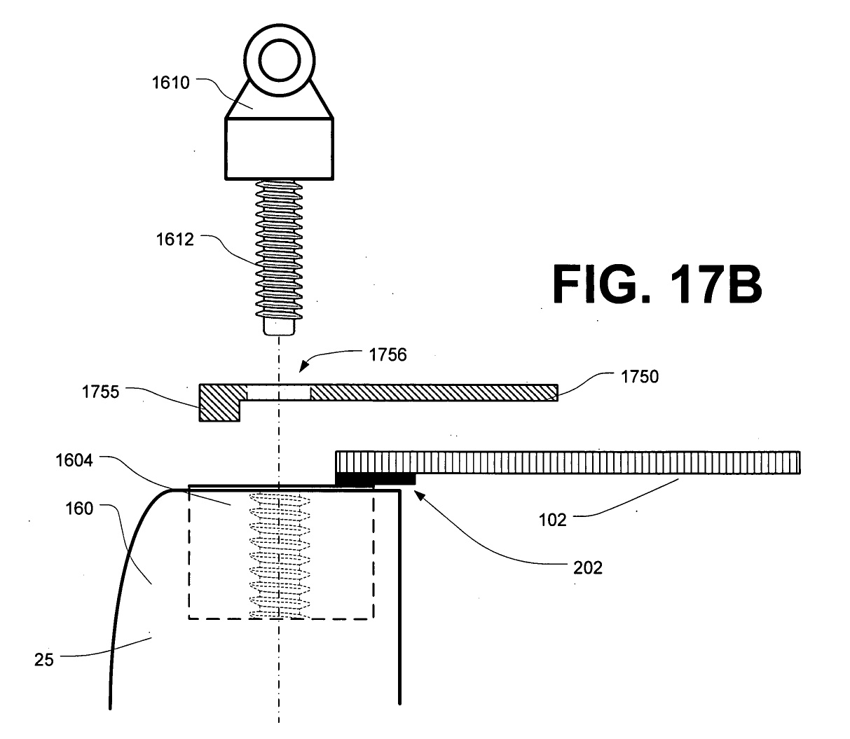

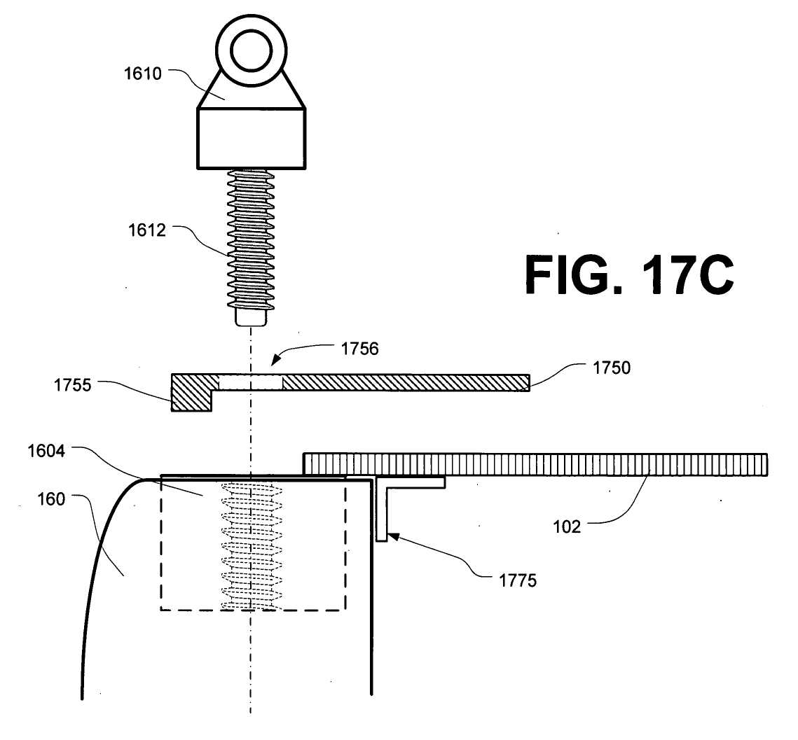

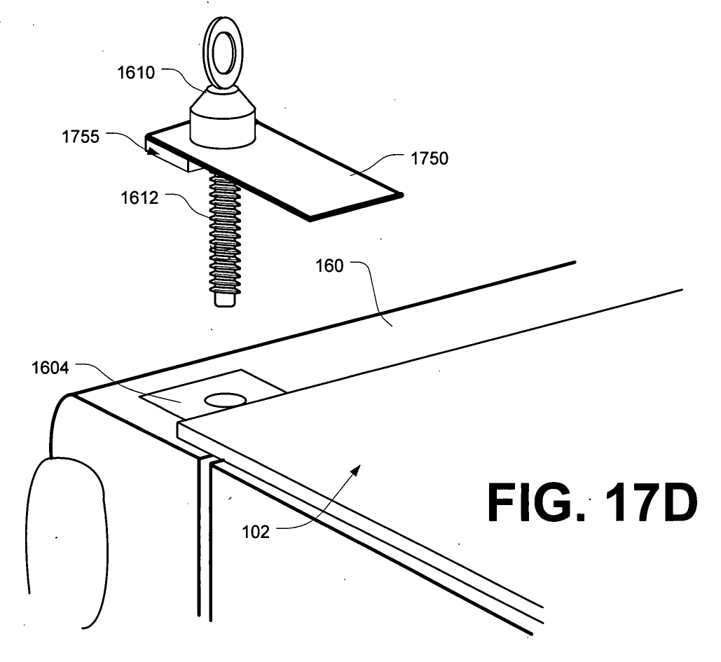

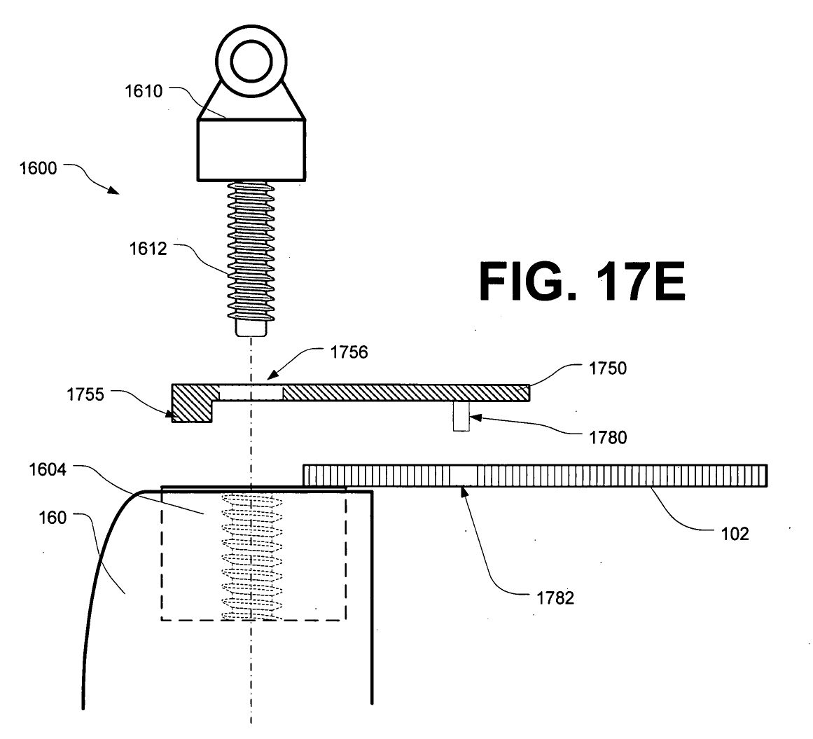

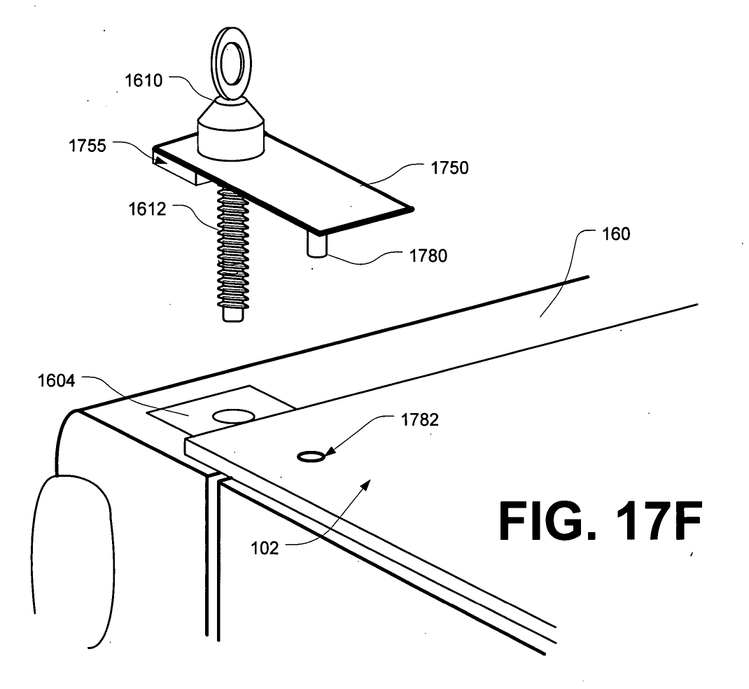

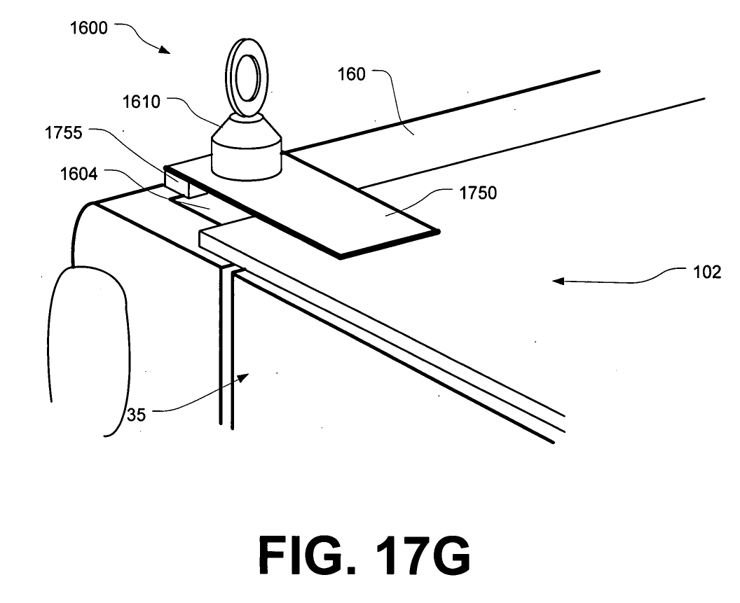

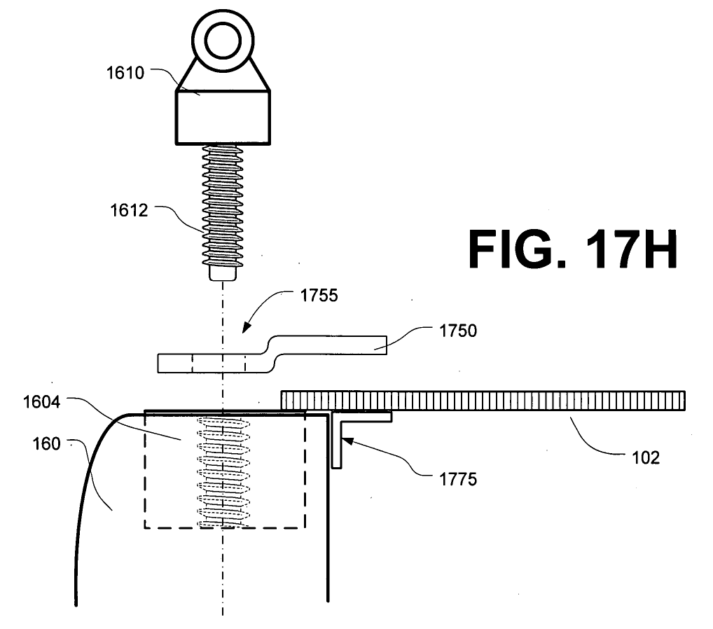

FIG. 16A-FIG. 17H are diagrams depicting an embodiment of the cargo bed cover 100 which takes advantage of existing tie down mechanisms that are installed on a pick-up truck 25. Several known tie down mechanisms 1600 exist which are designed to be inserted and installed into a stake pocket located on a sidewall 160 of a pickup truck cargo bed 30.

FIG. 16A is a diagram depicting a portion of a wall 160 of a cargo bed 30 of a pick-up truck 25. The side wall 160 includes a stake pocket 860. Typically, two to four stake pockets 860 are provided on a typical pick-up truck cargo bed side wall 160, each corresponding to and located near a corner of the cargo bed 35. A tie down mechanism 1600 is attached to the side wall 160 via a stake pocket 860. In this embodiment the tie down mechanism 1600 includes an “eye-bolt” 1610 which includes a threaded post 1612. The eye-bolt 1610 is threaded into a mounting base 1604 that is securely fitted into the stake pocket 860 so that it can not be removed without the application of great force or proper un-installation methods. The eye-bolt 1610 includes an eyelet 1611 and a threaded post 1612.

FIG. 16B-FIG. 16D are diagrams depicting one embodiment of the cover 100 installed on a pick-up truck 25 in conjunction with a concurrently installed or existing tie down mechanism 1600. It can be seen that the cover 100 is held in place between the eye-bolt head 1610 and the side wall 160 via the threaded post 1612 which is threaded into the mounting base 1604. In this embodiment, the cover 100 can not be removed without temporarily unscrewing the eye-bolt/tie down mechanism 1600 to release the cover 100 from it's secure position against the side wall 160. It can be seen that the tie down eye head 1610 is fully accessible and may be used to secure cargo on top of the cover 100, if so desired.

FIG. 17 A-17H are diagrams depicting an implementation of the cargo cover ramp 100 in which a clamp 1750 is provided to allow the panels 102/104 to be quickly and easily secured in conjunction with a concurrently installed known tie down mechanism 1600. Unlike the implementation shown and discussed above in conjunction with FIG. 16A-FIG. 16D, this implementation does not require the removal of the eye-bolt head 1610 in order to secure or release the cargo cover ramp 100 to/from on top of the sidewalls 160 of the cargo bed 30.

The clamp 1750 is configured so that it can be attached to the side wall 160 via the tie down mechanism 1600. The post 1612 of the tie down mechanism 1600 is passed thru an opening 1756 of the clamp 1750. The clamp 1750 is preferrably rotatable about the post 1612. In operation, the clamp 1750 is configured to extend over the top surface of one of the panels 102/104 of the cover 100. By tightening the tie down mechanism 1600 into the mounting base 1604, the clamp 1750 is caused to exert a downward force onto the top of the cover 100, thereby securing the edge of the cover 100 between the clamp 1750 and the top of the side wall 160 of the pick-up truck 25. In this embodiment, it is not necessary for the panels 102/104 of cargo bed cover 100 to extend over the stake pockets 860. Further, it is not necessary for the eye-bolt 1600 to be completely unscrewed/removed from the mounting base 1604 in order to open/close the cover 100 to access/secure cargo within the cargo bed 30.

FIG. 17B shows a diagram depicting a cut-away view showing details of the clamp 1750 and how it is mounted in relation to the tie down mechanism 1600 and the cover 100. Further, a clamp 1750 is provided that includes a leveling pin 1755 that is downwardly disposed. The leveling pin 1755 is approximately as deep as the cover 100 is thick and acts to level the clamp 1750 so that it extends across a plane substantially parallel to the cover 100.

In FIG. 17C, an embodiment of the cargo bed cover 100 is shown in which an alignment tab 1775 is provided. The alignment tab 1775 is provided at a predetermined set back from the outside edge of the panels 102/104 so that the cover 100 can be easily aligned in place on top of the side walls 160. By providing the alignment tab 1775, the cover 100 may be aligned substantially parallel to the side walls 160 of pick up truck cargo bed 30. FIG. 17D is a diagram depicting a further view illustrative of the tie down mechanism 1600 in relation to the side wall 160 and the cover 100.

FIG. 17E and FIG. 17F are diagrams depicting a further embodiment of the clamp 1750. In this embodiment, the clamp 1750 is configured to include an alignment pin 1780. The alignment pin 1780 extends downward and is positioned so that it can be introduced into an alignment opening 1782 that may be provided on the top surface of panel 102/104. When the clamp 1750 is tightened into place to secure the cover 100, the cover 100 may be moved adjusted so that it is in a position that will allow the alignment pin 1780 to enter the alignment opening 1782. Where multiple clamps 1750 having alignment pins 1780 are used to secure the cover 100, it is possible to put/keep the cover 100 in a position that is substantially square with the cargo bed 30. This will typically require that at least two clamps 1750 each be placed at or near a separate corner of the cargo bed cargo bed cover 100.

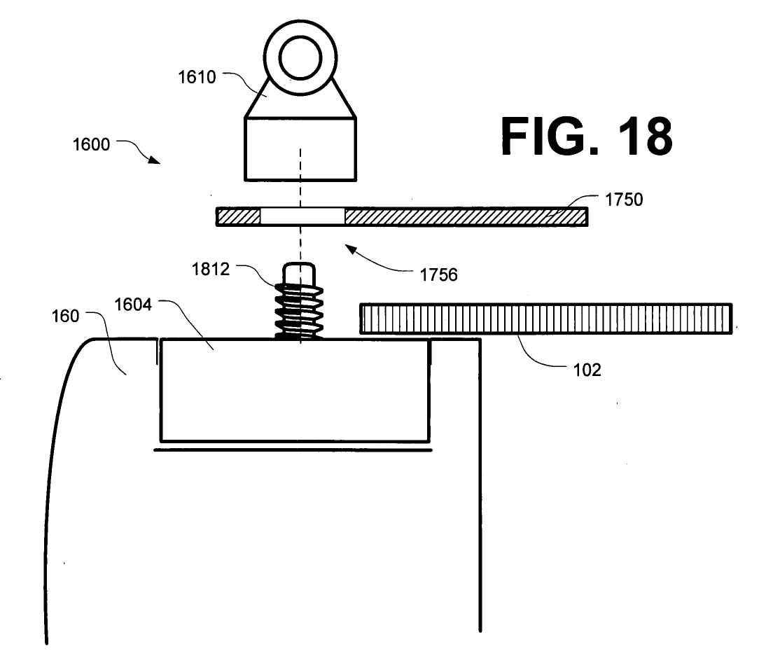

FIG. 17G illustrates a further embodiment of clamp 1750. IN this embodiment, the clamp 1750 is bent into an “s” like shape to so that the opposite ends of the clamp 1750 lie substantially in two separate planes that are substantially parallel to each other. This embodiment of the clamp 1750 may be formed via, for example, bending a single flat work piece into the desired shape. FIG. 18 is a diagram depicting an embodiment in which the tie down mechanism 1600 is configured so that a threaded post 1812 extends upward from the mounting base 1604.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1- A cargo bed cover comprising:
First panel attached to a first support beam;
Second panel attached to a second support beam;
Hinge connected to the first panel and to the second panel;
First traction surface disposed along a surface of the first panel;
Second traction surface disposed along a surface of the second panel;
The first panel comprises a latch opening for receiving a latch post; and
The second panel comprises a latch opening for receiving a latch post;

2- The cargo bed cover of claim 1 further comprising weather seal disposed along the seam between the first panel and the second panel.

3- The cargo bed cover of claim 2 wherein the weather seal covers the seam between the first panel and the second panel so as to preclude environmental elements from passing through the seam.

4- The cargo bed cover of claim 1 wherein said first and second traction surfaces comprise a pattern formed on a surface of each of the first and second panels.

5- The cargo bed cover of claim 4, wherein the pattern comprises a diamond plate pattern that is integrally formed in each of the first and second panels.

6- The cargo bed cover of claim 1 wherein the support strut comprises a post that is rotatable between a first position and a second position.

7- The cargo bed cover of claim 6 wherein the first and second panels each further comprise a seal material disposed substantially along the outer edges thereof.

8- An cargo bed cover comprising:
First panel attached to a first support beam;
Second panel attached to a second support beam;
Hinge connected to the first panel and to the second panel;
First traction surface disposed along a surface of the first panel;
Second traction surface disposed along a surface of the second panel;
The first panel comprises a latch opening;
The second panel comprises a second latch opening;
First latch mechanism disposed through the first latch opening;
Second latch mechanism disposed through the second latch opening;
First weather seal disposed along the seam between the first panel and the second panel;
Support strut attached to the first panel; and
Support strut attached to the second panel.

9- A cargo bed cover comprising:
A first panel comprising a metallic panel and a traction surface disposed on the top surface of the first panel;
A second panel comprising a metallic panel and a traction surface disposed the top surface of the second panel;
The first panel is joined to the second panel via a hinge system;
The first panel further comprises a first support beam attached to the bottom side of the first panel and that extends substantially along the length of the first panel;
The second panel further comprises a second support beam attached to the bottom side of the second panel and that extends substantially along the length of the second panel; and
clamp mechanism for interfacing with a cargo bed tie down mechanism.

10- The cargo bed cover of claim 9 further comprising an alignment mechanism for aligning the cargo cover with a cargo bed.

11- The cargo bed cover of claim 9 wherein the first panel further comprises a third and a fourth support beam attached to the bottom side of the first panel and extending substantially along the length of the first panel; and the second panel further comprises a fifth and a sixth support beam attached to the bottom side of the second panel and extending substantially along the length of the second panel.

12- The cargo bed cover of claim 11 wherein the first panel and the second panel each further comprise sealing material disposed along the outer edges thereof.

13- The cargo bed cover of claim 12 wherein the support strut comprises a post that is rotatable between a first position in which the post is substantially parallel to the plane in which the first panel lies and a second position in which the post is substantially perpendicular to the plane in which the first panel lies.

14- The cargo bed cover of claim 9 wherein the clamp mechanism comprises an opening for receiving a mounting post of a cargo bed tie down mechanism.

15- The cargo bed cover of claim 14 wherein the clamp mechanism further comprises a leveling pin.

16- The cargo bed cover of claim 10 wherein the alignment mechanism comprises an alignment pin extending from the clamp mechanism.

17- The cargo bed cover of claim 16 wherein the first panel further comprises an alignment opening for receiving the alignment pin of the clamp mechanism.

18- The cargo bed cover of claim 9 wherein the first panel and the second panel each further comprise a sealant disposed along the outer edges thereof.

19- The cargo bed cover of claim 18 wherein the first panel and the second panel comprise a diamond plate metal sheet wherein the traction surface is provided by the diamond plate surface pattern.

20- The cargo bed cover of claim 13 wherein the first and second support beams are configured to interface with a ground surface and distribute any load that may be placed on the cargo bed cover while it is extended between a ground surface and a tailgate.
